(19) United States
(12) Patent Application Publication
(10) Pub. No.: US 2026/0087331 A1
(43) Pub. Date: Mar. 26, 2026

(54) MODEL COMPRESSION FOR NEURAL NETWORKS

(71) Applicant: INTERNATIONAL BUSINESS MACHINES CORPORATION, ARMONK, NY (US)

(72) Inventors: SURIYA T SKARIAH, KOCHI (IN); PRASHANSHA GUPTA, BANGALORE (IN); RAHUL M RAO, BANGALORE (IN)

(21) Appl. No.: 18/895,537

(22) Filed: Sep. 25, 2024

(51) Int. Cl. G06N 3/0495; G06N 3/08

(52) U.S. Cl. CPC G06N 3/0495; G06N 3/08

(57) ABSTRACT

Model compression for neural networks, including: determining, during training of a neural network model, for each of a plurality of training iterations, a corresponding value for a plurality of weights; calculating, for each weight of the plurality of weights and based on the corresponding value for each of the plurality of weights, an importance metric; calculating a plurality of quantized weights by binning the plurality of weights based on the importance metric; and updating the neural network model based on the plurality of quantized weights.

### BACKGROUND

The present disclosure relates to methods, apparatus, and products for model compression for neural networks.

### SUMMARY

According to embodiments of the present disclosure, various methods, apparatus and products for model compression for neural networks are described herein. In some aspects, model compression for neural networks includes determining, during training of a neural network model, for each of a plurality of training iterations, a corresponding value for a plurality of weights; calculating, for each weight of the plurality of weights and based on the corresponding value for each of the plurality of weights, an importance metric; calculating a plurality of quantized weights by binning the plurality of weights based on the importance metric; and updating the neural network model based on the plurality of quantized weights. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a diagram of an example computing environment for model compression for neural networks in accordance with some embodiments of the present disclosure.

FIG. 2 sets forth a flowchart of an example method for model compression for neural networks in accordance with some embodiments of the present disclosure.

FIG. 3 sets forth a flowchart of another example method for model compression for neural networks in accordance with some embodiments of the present disclosure.

FIG. 4 sets forth a flowchart of another example method for model compression for neural networks in accordance with some embodiments of the present disclosure.

FIG. 5 sets forth a flowchart of another example method for model compression for neural networks in accordance with some embodiments of the present disclosure.

### DETAILED DESCRIPTION

As neural network models increase in both size and computational complexity, the amounts of resources required to deploy and use these models also increases. This may include, for example, increases in storage space required, inference time, and energy consumption. Model compression techniques may simplify a model so as to reduce its size and computational complexity. However, some compression techniques may negatively impact the accuracy of the original model. Moreover, some existing implementations for model compression require retraining, pruning, or other operations that are not based on insights gained during initial training of the model.

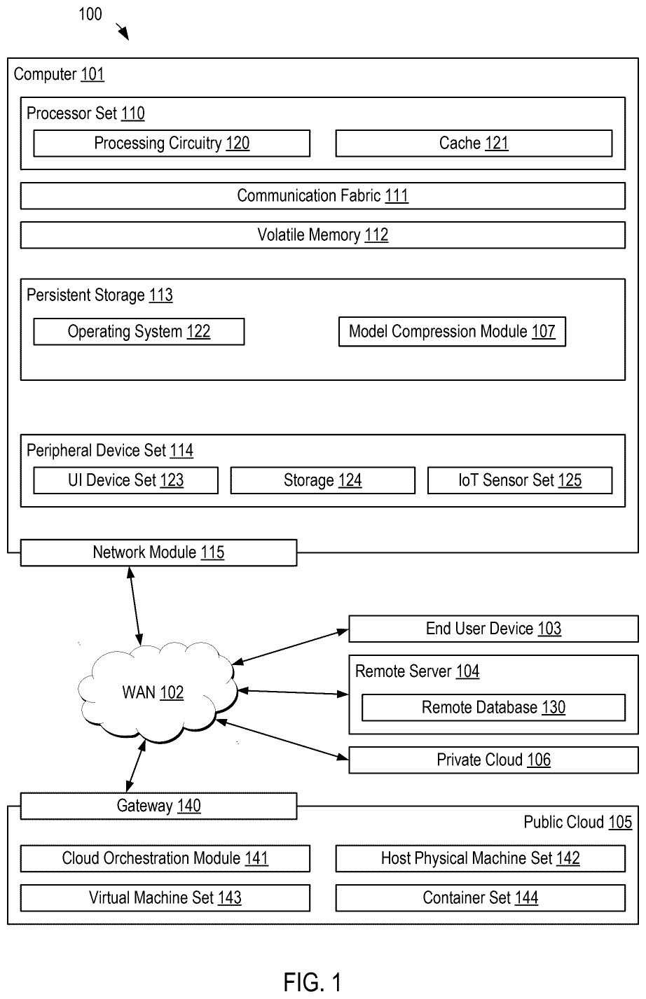

FIG. 1 sets forth an example computing environment according to aspects of the present disclosure. Computing environment 100 contains an example of an environment for the execution of at least some of the computer code involved in performing the various methods described herein, such as the model compression module 107. In addition to the model compression module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

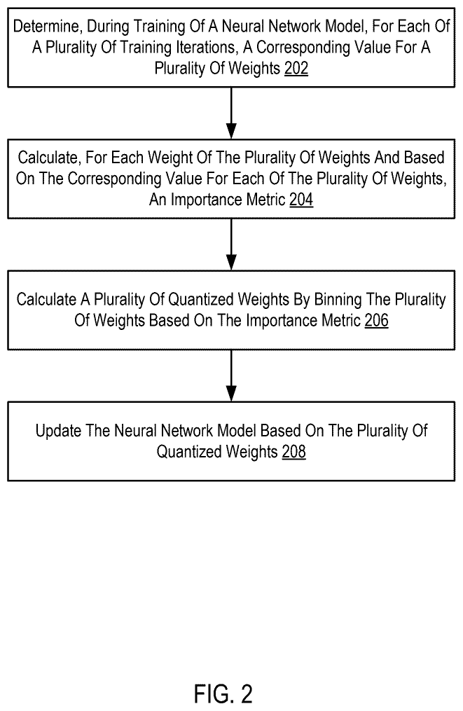

For further explanation, FIG. 2 sets forth a flowchart of an example method of model compression for neural networks in accordance with some embodiments of the present disclosure. The method of FIG. 2 may be performed, for example, by a model compression module 107 of FIG. 1. The method of FIG. 2 includes determining 202, during training of a neural network model, for each of a plurality of training iterations, a corresponding value for a plurality of weights. Although the following discussion is presented in the context of a neural network, readers will appreciate that the approaches set forth herein may also be applicable to other trained models. In some embodiments, training a neural network model may include multiple iterations of training performed on multiple portions of training data. As the neural network model is trained across these iterations, the values for various weights of the neural network model may change. Accordingly, the values for each of these weights are tracked across each training iteration of the neural network model. These values, and the ways in which these values change across training iterations, will be used to derive importance metrics for each of the weights as will be described in further detail below. After training of the neural network model has completed a trained version of the neural network model may be saved or stored.

The method of FIG. 2 also includes calculating 204, for each weight of the plurality of weights and based on the corresponding value for each of the plurality of weights, an importance metric. In other words, in some embodiments, an importance metric may be calculated for each weight of the plurality of weights based on the values of that weight for each of the plurality of training iterations. In some embodiments, the importance metric may include a coefficient of variation. A coefficient of variation is a ratio of a standard deviation to a mean. Accordingly, a coefficient of variation for a particular weight is the ratio of the standard deviation for the particular weight relative to the mean of the particular weight.

For example, in some embodiments, calculating a coefficient of variation of a particular weight may include finding, based on the values of the particular weight described above, the minimum value for the particular weight. In some embodiments, as the weights may be initialized randomly, values for one or more of the first epochs may be excluded from calculating the coefficient of variation to improve accuracy. In some embodiments, after finding the minimum value for the particular weight, the values for the particular weight may be updated by subtracting the minimum value from each weight. In some embodiments, the mean and standard deviation of these updated weights may be calculated. The coefficient of variation may then be calculated using the calculated mean and standard deviation.

In some embodiments, as will be described in further detail below, a direction of change may also be calculated for each weight. Accordingly, in some embodiments, the direction of change may also be considered an importance metric for weights of the neural network model.

The method of FIG. 2 also includes calculating 206 a plurality of quantized weights by binning the plurality of weights based on the importance metric. In other words, for each weight of the plurality of weights, a corresponding quantized weight may be calculated based on its importance metric. Quantizing a particular weight reduces the precision for that weight so as to reduce the overall storage space required by the neural network model. As referred to herein, binning describes the process of assigning a weight to a particular cluster or grouping of weights. A particular weight may be quantized by mapping the particular weight to a particular centroid of a cluster to which the particular weight is assigned.

In some embodiments, binning the plurality of weights may include a non-uniform, non-weighted binning approach whereby a subset of the plurality of weights is selected based on their respective importance metric. This subset of weights is then clustered. A remainder of the plurality of weights (e.g., not included in the selected subset) are then assigned to their nearest centroids. In some embodiments, binning the plurality of weights may include a non-uniform, weighted binning approach whereby all weights are clustered and scaled based on their respective importance metric. Specific details for these binning approaches are set forth in further detail below in subsequent flowcharts.

The method of FIG. 2 also includes updating 208 the neural network model based on the plurality of quantized weights. In other words, each weight in the neural network model may be replaced with its corresponding quantized weight. In some embodiments, after updating 208 the neural network model, the accuracy of the updated model may be compared to the accuracy of the original model. In some embodiments, the approaches described herein may be repeatedly performed (e.g., using different binning techniques, using different numbers of clusters when binning) in order to generate multiple updated models. In some embodiments, a particular updated model may be selected for use as having a highest accuracy, as having a difference in accuracy relative to the original model falling below some threshold, and the like.

Readers will appreciate that the approaches set forth herein provide for compression of a neural network model by quantizing the weights of the neural network model while maintaining or minimizing loss of accuracy. Particularly, the approaches set forth herein use insights gained during training (e.g., the importance metrics based on how weight values change during training) and do not require retraining or post-compression pruning or retuning of the neural network model.

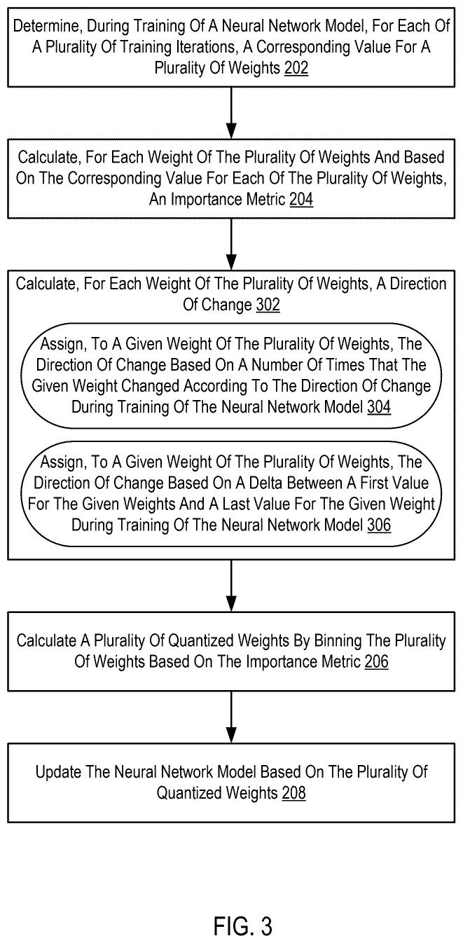

For further explanation, FIG. 3 sets forth a flowchart of an example method of model compression for neural networks in accordance with some embodiments of the present disclosure. The method of FIG. 3 is similar to FIG. 2 in that the method of FIG. 3 also includes: determining 202, during training of a neural network model, for each of a plurality of training iterations, a corresponding value for a plurality of weights; calculating 204, for each weight of the plurality of weights and based on the corresponding value for each of the plurality of weights, an importance metric; calculating 206 a plurality of quantized weights by binning the plurality of weights based on the importance metric; and updating 208 the neural network model based on the plurality of quantized weights.

The method of FIG. 3 differs from FIG. 2 in that the method of FIG. 3 also includes: calculating 302, for each weight of the plurality of weights, a direction of change. In some embodiments, the direction of change for a particular weight may be used as an importance metric when binning weights, described in further detail below. The direction of change for a particular weight describes whether the particular weight increases, decreases, or stays the same across training iterations. This may describe how the particular weight predominantly changes across training iterations or how the particular weight changes between the first and last training iterations.

In some embodiments, calculating 302, for each weight of the plurality of weights, a direction of change may include assigning 304, to a given weight of the plurality of weights, the direction of change based on a number of times that the given weight changed according to the direction of change during training of the neural network model. In other words, in some embodiments, the direction of change for the particular weight may be based on whether the particular weight predominantly increases, decreases, or stays the same across epochs of the model.

For example, in some embodiments, three counters may be initialized: count_inc (the number of times the particular weight increased), count_dec (the number of times the particular weight decreased), and count_neutral (the number of times the particular weight remained the same). The values for the particular weight may be iterated through and the values for Wₙ and Wₙ₊₁ may be compared. Where Wₙ₊₁>Wₙ+0.0005, count_inc may be incremented. Where Wₙ₊₁<Wₙ−0.0005, count_dec may be decremented. Where Abs((Wₙ₊₁−Wₙ)<0.0005, count_neutral may be incremented. In the examples above, the use of the value “0.0005” in these comparisons reflects a change of less than 0.0005 being deemed as negligible. Readers will appreciate that, in some embodiments, other values may also be used in these comparisons to reflect a negligible change, or no such value may be used.

After updating each of these counters, the direction of change may then be determined based on which counter has the highest value. For example, a particular weight may have an increasing direction of change where count_inc is the highest, a decreasing direction of change where count_dec is the highest, and the like. In some embodiments, the direction of change may be expressed as a number. For example, an increasing direction of change may be expressed as one, a decreasing direction of change may be expressed as negative one, and a neutral direction of change may be expressed as zero.

In some embodiments, calculating 302, for each weight of the plurality of weights, a direction of change may include assigning 306, to a given weight of the plurality of weights, the direction of change based on a delta between a first value for the given weights and a last value for the given weight during training of the neural network model. For example, where a particular weight increases between the first and last value, the direction of change may be determined to increase. As another example, where a particular weight decreases between the first and last value, the direction of change may be determined to decrease. In some embodiments, these directions of change may also be expressed as a number as described above. In some embodiments, a threshold value reflecting a negligible change may also be used. For example, a particular weight may be determined to increase only where the difference between the first and last value is greater than the threshold value (e.g., 0.0005). As another example, where the absolute value of the difference between the first and last value is less than the threshold value, the direction of change may be determined to be neutral.

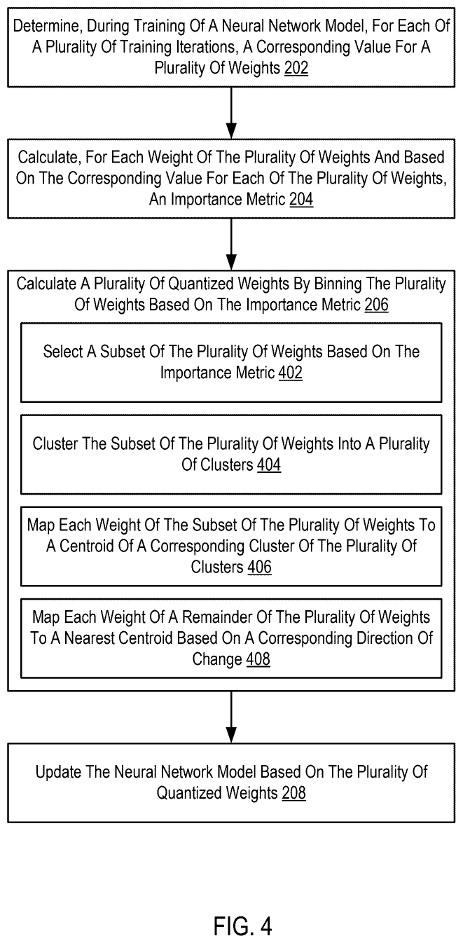

For further explanation, FIG. 4 sets forth a flowchart of an example method of model compression for neural networks in accordance with some embodiments of the present disclosure. The method of FIG. 4 is similar to FIG. 2 in that the method of FIG. 4 also includes: determining 202, during training of a neural network model, for each of a plurality of training iterations, a corresponding value for a plurality of weights; calculating 204, for each weight of the plurality of weights and based on the corresponding value for each of the plurality of weights, an importance metric; calculating 206 a plurality of quantized weights by binning the plurality of weights based on the importance metric; and updating 208 the neural network model based on the plurality of quantized weights.

The method of FIG. 4 differs from FIG. 2 in that calculating 206 a plurality of quantized weights by binning the plurality of weights based on the importance metric also includes selecting 402 a subset of the plurality of weights based on the importance metric (e.g., the coefficient of variation). The method of FIG. 3 describes approaches for non-uniform, non-weighted binning of weights. In some embodiments, some number of clusters for performing the binning operation is determined. This number of clusters will correspond to the number of unique weights for the updated neural network model.

The subset of weights may then be selected 402 based on the coefficient of variation according to various approaches. In some embodiments, all weights may be selected for inclusion in the subset. In some embodiments, the top N weights sorted in ascending or descending order based on their coefficient of variation may be selected for inclusion in the subset. In some embodiments, a random selection of the top N weights may be selected for inclusion in the subset. Other approaches may also be used in selecting 402 the subset of weights.

Calculating 206 a plurality of quantized weights by binning the plurality of weights also includes clustering 404 the subset of the plurality of weights into a plurality of clusters. For example, the subset of the plurality of weights may be clustered using k-means or some other clustering algorithm as can be appreciated. Calculating 206 a plurality of quantized weights by binning the plurality of weights also includes mapping 406 each weight of the subset of the plurality of weights to a centroid of a corresponding cluster of the plurality of clusters. In other words, each weight in the subset of weights will be mapped to the centroid of the cluster into which that weight is included.

Calculating 206 a plurality of quantized weights by binning the plurality of weights also includes mapping 408 each weight of a remainder of the plurality of weights to a nearest centroid based on a corresponding direction of change. In other words, using a direction of change determined as described above, a particular weight excluded from the previously selected subset will be mapped to a nearest centroid based on its direction of change. For example, assume that a particular weight having value W falls between two centroid values Cₙ and Cₙ₊₁ (e.g., Cₙ<W<Cₙ₊₁). Where the direction of change for the particular weight is increasing, the value for that weight may be rounded up, thereby mapping the particular weight to centroid C_{N+1}. Where the direction of change for the particular weight is decreasing, the value for that weight may be rounded down, thereby mapping the particular weight to centroid C_{N}. Where the direction of change for the particular weight is neutral, the value for that weight may be rounded to the nearest centroid. In other words, a particular weight may be mapped to one of the two nearest centroids based on its direction of change. In some embodiments, this rounding may be subject to a resulting error falling below some threshold. In some embodiments, where the weight for a particular value does not fall between two centroid values, that weight may then be mapped to the singular nearest centroid value.

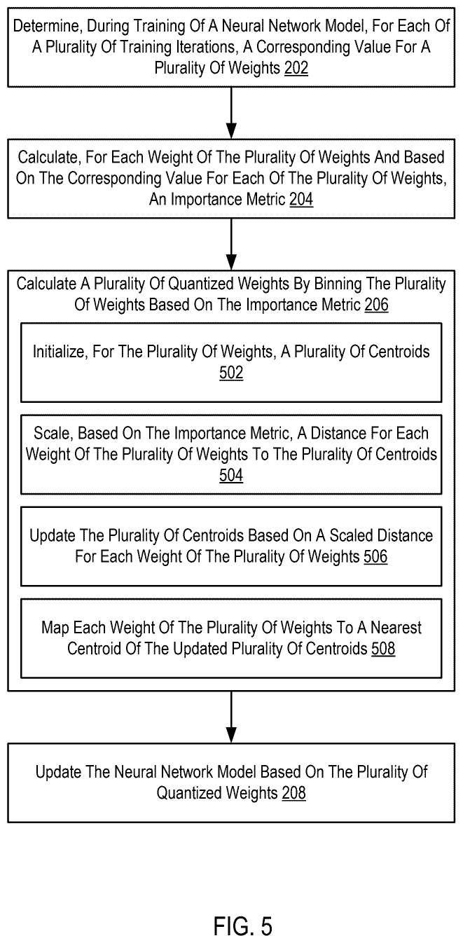

For further explanation, FIG. 5 sets forth a flowchart of an example method of model compression for neural networks in accordance with some embodiments of the present disclosure. The method of FIG. 5 is similar to FIG. 2 in that the method of FIG. 5 also includes: determining 202, during training of a neural network model, for each of a plurality of training iterations, a corresponding value for a plurality of weights; calculating 204, for each weight of the plurality of weights and based on the corresponding value for each of the plurality of weights, an importance metric; calculating 206 a plurality of quantized weights by binning the plurality of weights based on the importance metric; and updating 208 the neural network model based on the plurality of quantized weights.

The method of FIG. 5 differs from FIG. 2 in that calculating 206 a plurality of quantized weights by binning the plurality of weights based on the importance metric also includes initializing 502, for the plurality of weights, a plurality of centroids. For example, in some embodiments, a number of clusters corresponding to a number of unique quantized weights may be determined. A clustering of the plurality of weights may begin by initializing 502 (e.g., randomly) a number of centroids corresponding to the determined number of clusters.

Calculating 206 a plurality of quantized weights by binning the plurality of weights based on the importance metric also includes scaling 504, based on the importance metric, a distance for each weight of the plurality of weights to the plurality of centroids. For example, in some embodiments, the importance metric (e.g., the coefficient of variation) for each of the plurality of weights may be normalized to a range of zero to one, with the minimum value being normalized to zero and the maximum value being normalized to one. After normalizing the coefficients of variation, a distance of each weight to the centroids may be calculated. These distances may then be scaled using the normalized coefficients of variation.

Calculating 206 a plurality of quantized weights by binning the plurality of weights based on the importance metric also includes: updating 506 the plurality of centroids based on a scaled distance for each weight of the plurality of weights, and mapping 508 each weight of the plurality of weights to a nearest centroid of the updated plurality of centroids. In some embodiments, after scaling 504 the distances of the plurality of weights to the initial centroids, the centroids may be updated 506 based on these scaled distances (e.g., using a weighted average approach). Each of the plurality of weights may then be mapped 508 to the corresponding centroid of the cluster in which they are included.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining, during training of a neural network model, for each of a plurality of training iterations, a corresponding value for a plurality of weights;
calculating, for each weight of the plurality of weights and based on the corresponding value for each of the plurality of weights, an importance metric;
calculating a plurality of quantized weights by binning the plurality of weights based on the importance metric; and
updating the neural network model based on the plurality of quantized weights.

2. The method of claim 1, wherein the importance metric comprises a coefficient of variation.

3. The method of claim 1, further comprising calculating, for each weight of the plurality of weights, a direction of change.

4. The method of claim 3, wherein calculating, for each weight of the plurality of weights, the direction of change comprises assigning, to a given weight of the plurality of weights, the direction of change based on a number of times that the given weight changed according to the direction of change during training of the neural network model.

5. The method of claim 3, wherein calculating, for each weight of the plurality of weights, the direction of change comprises assigning, to a given weight of the plurality of weights, the direction of change based on a delta between a first value for the given weights and a last value for the given weight during training of the neural network model.

6. The method of claim 1, wherein calculating the plurality of quantized weights comprises:
selecting a subset of the plurality of weights based on the importance metric;
clustering the subset of the plurality of weights into a plurality of clusters;
mapping each weight of the subset of the plurality of weights to a centroid of a corresponding cluster of the plurality of clusters; and
mapping each weight of a remainder of the plurality of weights to a nearest centroid based on a corresponding direction of change.

7. The method of claim 1, wherein calculating the plurality of quantized weights comprises:
initializing, for the plurality of weights, a plurality of centroids;
scaling, based on the importance metric, a distance for each weight of the plurality of weights to the plurality of centroids;
updating the plurality of centroids based on a scaled distance for each weight of the plurality of weights; and
mapping each weight of the plurality of weights to a nearest centroid of the updated plurality of centroids.

8. An apparatus comprising:
a memory; and
a processing device operatively coupled to the memory, the processing device configured to:
determine, during training of a neural network model, for each of a plurality of training iterations, a corresponding value for a plurality of weights;
calculate, for each weight of the plurality of weights and based on the corresponding value for each of the plurality of weights, an importance metric;
calculate a plurality of quantized weights by binning the plurality of weights based on the importance metric; and
update the neural network model based on the plurality of quantized weights.

9. The apparatus of claim 8, wherein the importance metric comprises a coefficient of variation.

10. The apparatus of claim 8, wherein the processing device is further configured to calculate, for each weight of the plurality of weights, a direction of change.

11. The apparatus of claim 10, wherein, to calculate, for each weight of the plurality of weights, the direction of change, the processing device is further configured to assign, to a given weight of the plurality of weights, the direction of change based on a number of times that the given weight changed according to the direction of change during training of the neural network model.

12. The apparatus of claim 10, wherein, to calculate, for each weight of the plurality of weights, the direction of change, the processing device is further configured to assign, to a given weight of the plurality of weights, the direction of change based on a delta between a first value for the given weights and a last value for the given weight during training of the neural network model.

13. The apparatus of claim 8, wherein to calculate the plurality of quantized weights, the processing device is configured to:
select a subset of the plurality of weights based on the importance metric;
cluster the subset of the plurality of weights into a plurality of clusters;
map each weight of the subset of the plurality of weights to a centroid of a corresponding cluster of the plurality of clusters; and
map each weight of a remainder of the plurality of weights to a nearest centroid based on a corresponding direction of change.

14. The apparatus of claim 8, wherein to calculate the plurality of quantized weights, the processing device is configured to:
initialize, for the plurality of weights, a plurality of centroids;
scale, based on the importance metric, a distance for each weight of the plurality of weights to the plurality of centroids;
update the plurality of centroids based on a scaled distance for each weight of the plurality of weights; and
map each weight of the plurality of weights to a nearest centroid of the updated plurality of centroids.

15. A non-transitory computer readable storage medium storing instructions which, when executed, cause a processing device to:
determine, during training of a neural network model, for each of a plurality of training iterations, a corresponding value for a plurality of weights;
calculate, for each weight of the plurality of weights and based on the corresponding value for each of the plurality of weights, an importance metric;
calculate a plurality of quantized weights by binning the plurality of weights based on the importance metric; and
update the neural network model based on the plurality of quantized weights.

16. The non-transitory computer readable storage medium of claim 15, wherein the importance metric comprises a coefficient of variation.

17. The non-transitory computer readable storage medium of claim 15, wherein the processing device is further configured to calculate, for each weight of the plurality of weights, a direction of change.

18. The non-transitory computer readable storage medium of claim 17, wherein, to calculate, for each weight of the plurality of weights, the direction of change, the instructions, when executed, cause the processing device to assign, to a given weight of the plurality of weights, the direction of change based on a number of times that the given weight changed according to the direction of change during training of the neural network model.

19. The non-transitory computer readable storage medium of claim 17, wherein, to calculate, for each weight of the plurality of weights, the direction of change, the instructions, when executed, cause the processing device to assign, to a given weight of the plurality of weights, the direction of change based on a delta between a first value for the given weights and a last value for the given weight during training of the neural network model.

20. The non-transitory computer readable storage medium of claim 15, wherein to calculate the plurality of quantized weights, the instructions, when executed, cause the processing device to:
select a subset of the plurality of weights based on the importance metric;
cluster the subset of the plurality of weights into a plurality of clusters;
map each weight of the subset of the plurality of weights to a centroid of a corresponding cluster of the plurality of clusters; and
map each weight of a remainder of the plurality of weights to a nearest centroid based on a corresponding direction of change.
